(19) United States
(12) Patent Application Publication
(10) Pub. No.: US 2002/0116280 A1
(43) Pub. Date: Aug. 22, 2002

(54) Apparatus, system, method and computer program product for aggregating marketplaces

(75) Inventors: Stephen J. Boies, Mahopac, NY (US); Samuel H. Dinkin, Austin, TX (US); David Perry Greene, Ossining, NY (US); William Grey, Millwood, NY (US); Paul Andrew Moskowitz, Yorktown Heights, NY (US); Philip S. Yu, Chappaqua, NY (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/789,891

(22) Filed: Feb. 20, 2001

(51) Int. Cl. G06F 17/60

(52) U.S. Cl. 705/26

(57) ABSTRACT

An apparatus, system, method and computer program product for aggregating multiple marketplaces is provided. The apparatus, system, method and computer program product provide a mechanism by which users may obtain information regarding various goods and services suppliers registered with various marketplaces from a central location. The apparatus, system, method and computer program product further provide a uniform interface through which users may place orders for goods and/or services, obtain information from goods and services suppliers, and otherwise interface with goods and service suppliers. In so doing, the search time for searching for desired goods and services, transaction costs, and time and money spent on activities such as monitoring, maintaining, and coordinating bids and offers is reduced.

### BACKGROUND OF THE INVENTION

1. Technical Field

The present invention provides an apparatus, system, method and computer program product for aggregating marketplaces. More specifically, the present invention provides a mechanism by which information concerning multiple disparate marketplaces, and suppliers associated with those marketplaces, is aggregated and useable by client devices to access these marketplaces and suppliers.

2. Description of Related Art

When purchasers of goods and services wish to transact business in multiple marketplaces, the purchaser must typically do so by identifying appropriate markets for a given good or service and search each marketplace individually for the desired good or service. Listings of goods and services for each of the multiple marketplaces may be displayed in different formats that make them difficult to compare. With some marketplaces, such as auction marketplaces for example, time must be spent monitoring, maintaining, and coordinating bids. When multiple auction marketplaces are being monitored, each having different formats, it becomes difficult to effectively maintain and coordinate bids. Moreover, different bid formats also make the bidding process difficult to automate.

From the standpoint of the suppliers of goods and services wishing to transact business in multiple marketplaces, the suppliers must identify appropriate markets for their goods and services and list them with the marketplaces individually. In addition, exclusivity rules in certain marketplaces may limit the ability of suppliers to submit multiple listings. Even in the absence of exclusivity rules, suppliers may incur additional costs to place listings in multiple marketplaces and will be required to enter listing information multiple times.

Furthermore, time must be spent monitoring and maintaining offers received from buyers on multiple marketplaces and different offer formats makes the process difficult to automate. Thus, it would be beneficial to have an apparatus, system, method and computer program product for aggregating a plurality of disparate marketplaces for use by purchasers and suppliers of goods and services.

### SUMMARY OF THE INVENTION

The present invention provides an apparatus, system, method and computer program product for aggregating multiple marketplaces. The present invention provides a mechanism by which users may obtain information regarding various goods and services suppliers registered with various marketplaces from a central location. The present invention further provides a uniform interface through which users may place orders for goods and/or services, obtain information from goods and services suppliers, and otherwise interface with goods and service suppliers. In so doing, the present invention reduces search time for searching for desired goods and services, reduces transaction costs, and reduces the time and money spent on activities such as monitoring, maintaining, and coordinating bids and offers.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram of a distributed data processing system for placing orders in accordance with the present invention;

FIG. 2 is an exemplary block diagram of a data processing system that may be used to implement the server of the present invention;

FIG. 3 is an exemplary block diagram of a data processing system that may be used to implement a client system in accordance with the present invention;

FIG. 4 is an exemplary diagram illustrating a virtual marketplace aggregator according to the present invention;

FIG. 5 is an exemplary block diagram illustrating primary components of a virtual marketplace aggregator;

FIG. 6 is an exemplary diagram illustrating a marketplace data structure according to the present invention;

FIG. 7 is a flowchart outlining an exemplary operation of the present invention when compiling marketplace information from various marketplaces on network; and

FIG. 8 is a flowchart outlining an exemplary operation of the present invention when interacting with a user via a client device.

### DETAILED DESCRIPTION OF THE PREFERRED EMBODIMENTS

The following description of the preferred embodiments will repeatedly refer to “marketplaces.” The term “marketplaces” as it is used throughout this disclosure is intended to refer to business network sites, such as Internet e-business web sites, and the accompanying hardware/software to support such business network sites. Such “marketplaces” provide a medium through which multiple goods/services suppliers may offer their goods/services for sale to consumers. Examples of such “marketplaces” include E2open (available at www.e2open.com) and covisint (available at www.covisint.com).

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, servers 104, 110 and 112 are connected to network 102 along with storage unit 106. In addition, client 108 is also connected to network 102. These client 108 may be, for example, a personal computer, personal digital assistant, Web appliance, network computer, or the like. In the depicted example, server 104 provides data, such as boot files, operating system images, and/or applications to client 108. Client 108 is a client to servers 104, 110 and 112. Network data processing system 100 may include additional servers, clients, and other devices not shown.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

The servers 104, 110 and 112 maybe, for example, goods/services supplier servers on which the goods/services of the suppliers are advertised and/or offered for sale. In addition, one or more of the servers 104, 110 and 112 may host network marketplaces through which a plurality of goods/services suppliers may market their goods/services. For example, the network marketplaces may provide information regarding the goods/services supplier's goods and/or services, the supplier's network site, provide links to the supplier's network site, and the like.

With the distributed data processing system 100, the client 108 may access information on servers 104, 110 and 112 using a web browser application and an accepted communication protocol, such as Hypertext Transport Protocol (HTTP). Using the web browser, a user of the client 108 may either enter an address for the various network sites resident on servers 104, 110 and 112, such as a Uniform Resource Locator (URL), or may perform a search using a search engine and select a corresponding hyperlink to the network sites. In addition, if one of the servers 104, 110 or 112 hosts a network marketplace, the user may access the marketplace in the manner set forth above, obtain information about the various suppliers registered with the marketplace, and access the supplier through hyperlinks associated with the marketplace.

With such a distributed data processing system 100, however, there are drawbacks in that the user of the client 108 must perform a search for the various suppliers' network sites and/or marketplaces or know the address of the suppliers' network sites and marketplaces. The user must then visit each of the suppliers' network sites individually or each of the marketplaces individually in order to obtain information regarding the various goods/services offered. Each network site may have its own format and manner of accepting orders and thus, having to interact with so many different formats may frustrate the user.

In addition, goods/services suppliers must register with multiple search engines and marketplaces in order to maximize their exposure to potential customers. Moreover, with presently known marketplaces, the types of goods/services suppliers allowed to register with the marketplace is restricted to the specific goods/services category handled by that marketplace. For example, a marketplace that provides information regarding jewelry distributors is not going to allow a computer software supplier to register with their marketplace, and vice versa.

In addition, many known marketplaces include exclusivity restrictions that limit the goods/services supplier's ability to register with other marketplaces. Thus, if a goods/services supplier wishes to register with a particular marketplace, they may be foreclosed from increasing their exposure by registering with other marketplaces.

In order to overcome these problems with the known systems, the present invention includes a virtual marketplace aggregator 120. The virtual marketplace aggregator 120 aggregates the various marketplace information from a plurality of marketplaces and presents it to a user of a client device in a uniform manner. The virtual marketplace aggregator 120 obtains information regarding the various goods/services suppliers registered with the various marketplaces, obtains virtual catalog information if possible, transaction format information, and the like.

The virtual marketplace aggregator 120 may then provide the user with a virtual “shopping mall” of goods/services suppliers thereby allowing suppliers of dissimilar goods to market their wares in a central site. The user need only search one network site to obtain information regarding a plurality of marketplaces and suppliers rather than visiting each marketplace and supplier network site individually.

In addition, the virtual marketplace aggregator 120 provides a uniform mechanism for placing orders such that users are not frustrated with having to become acquainted with a plurality of different formats. The orders obtained using the uniform format may then be translated by the virtual marketplace aggregator 120 into the transaction format used by the individual suppliers.

Moreover, goods/services suppliers need only register with one marketplace rather than multiple marketplaces and still be included in the listing of suppliers in the virtual marketplace aggregator 120. Additionally, the virtual marketplace aggregator 120 may periodically search the network for new marketplaces and/or suppliers registered to existing marketplaces, to update the virtual marketplace aggregator's listing of marketplaces and suppliers. If a new marketplace and/or supplier is identified, the virtual marketplace aggregator 120 may request the necessary information from the marketplace and/or supplier to thereby, register the marketplace and/or supplier with the virtual marketplace aggregator 120.

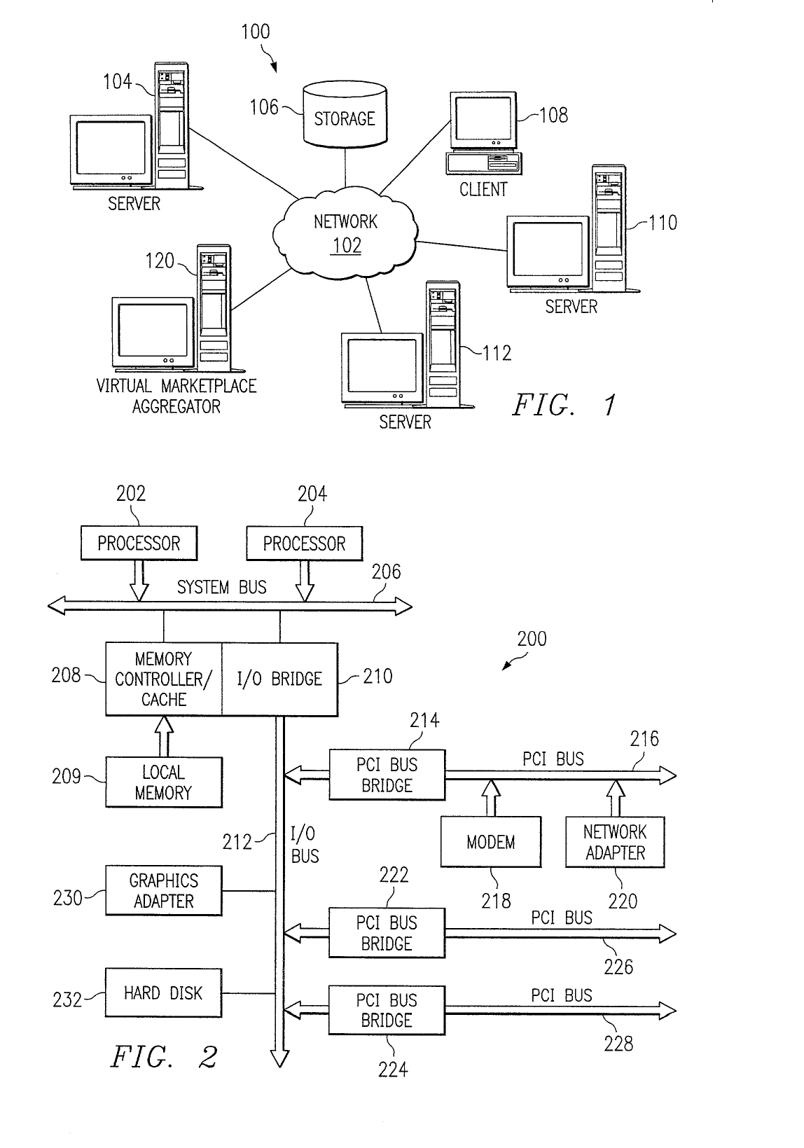

Referring to FIG. 2, a block diagram of a data processing system that may be implemented as a server, such as server 104 in FIG. 1, is depicted in accordance with a preferred embodiment of the present invention. In addition, the virtual marketplace aggregator 120 may be implemented in a server such as that shown in FIG. 2.

As depicted, data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

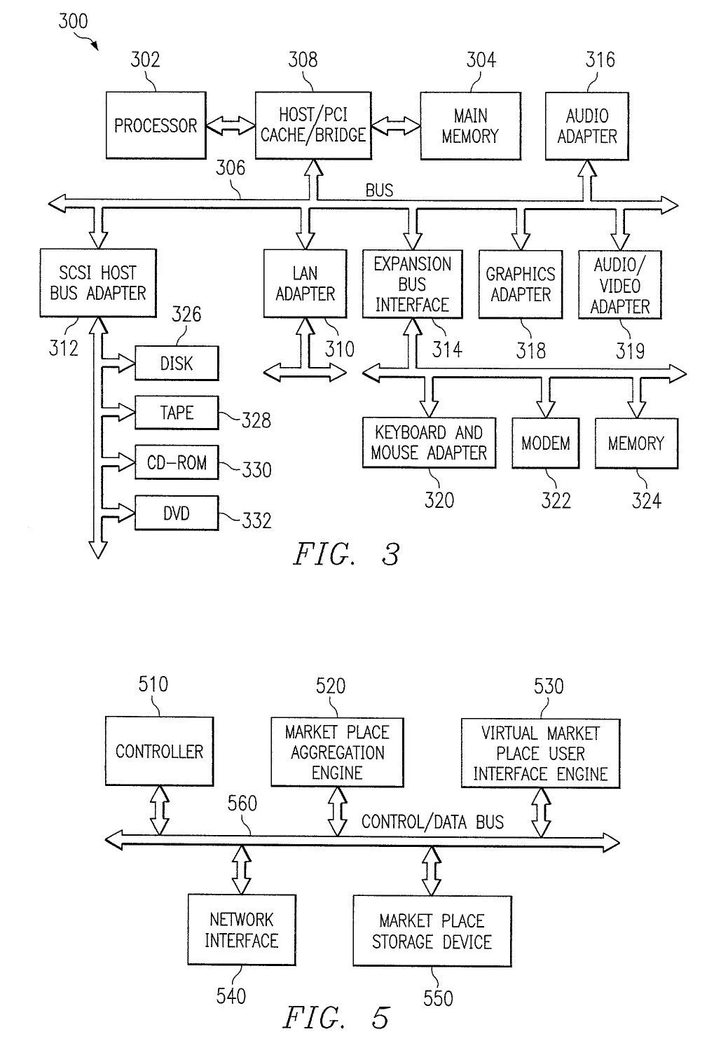

With reference now to FIG. 3, a block diagram illustrating a data processing system is depicted in which the present invention may be implemented. Data processing system 300 is an example of a client computer. Data processing system 300 employs a peripheral component interconnect (PC) local bus architecture. Although the depicted example employs a PCI bus, other bus architectures such as Accelerated Graphics Port (AGP) and Industry Standard Architecture (ISA) may be used.

Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots.

Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Linux or Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

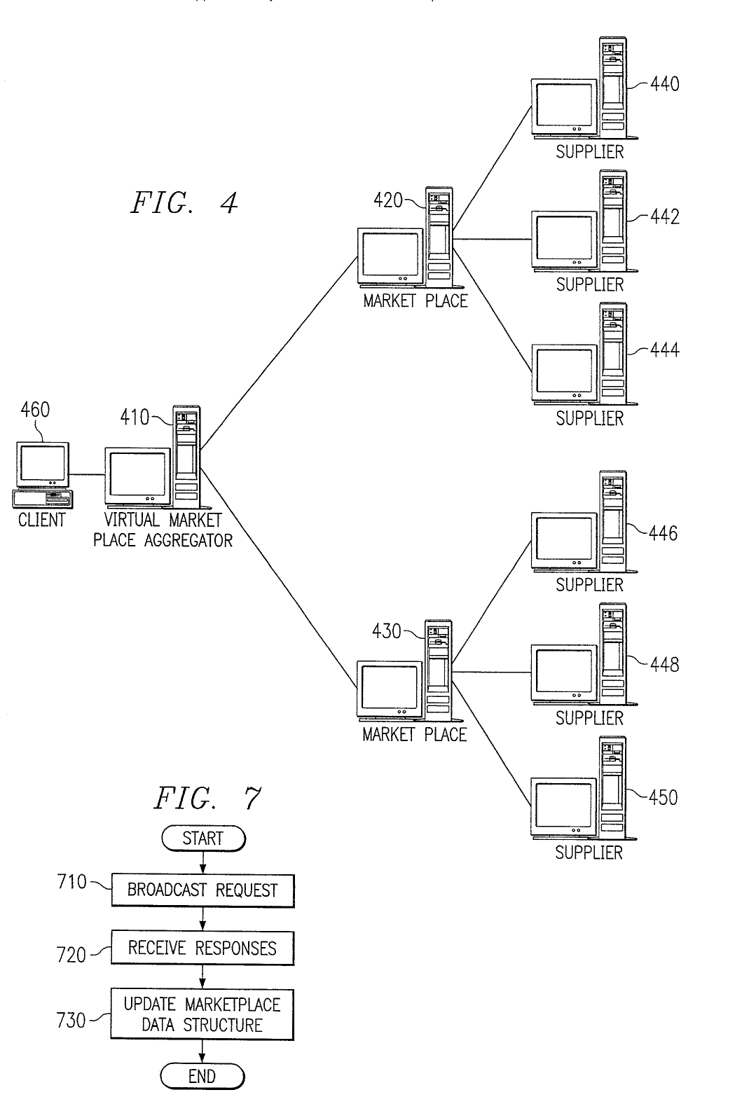

FIG. 4 is an exemplary diagram illustrating the manner by which marketplaces are aggregated using the virtual marketplace aggregator of the present invention. As shown in FIG. 4, marketplaces 420 and 430 have a plurality of suppliers 440-450 registered with the marketplaces, respectively. By “registering” with the marketplaces, what is meant is that the suppliers provide the marketplaces with information relating to the catalog of products/services provided via the supplier's network site, the transaction format used by the supplier's order processing software, the supplier's network site address, and the like. In addition, the supplier may actually store web pages on the marketplace server for use when a potential customer accesses the marketplace and requests information regarding the supplier.

The suppliers 440-444 will typically be directed to the same general category of goods/services. Similarly, the suppliers 446-450 will also be directed to the same general category of goods/services, although they may be different from those of suppliers 440-444. There may be many more suppliers, marketplaces, virtual marketplace aggregators, and the like, in the distributed data processing system according to the present invention than are depicted in FIG. 4. These other suppliers and marketplaces may handle many different types of goods and/or services.

The suppliers 440-450 register with the marketplaces 420 and 430. The virtual marketplace aggregator 410 obtains information regarding each of the marketplaces 420 and 430 as well as any goods/service suppliers registered with the marketplaces 420 and 430. In this way, the virtual marketplace aggregator 410 aggregates the information from each of the marketplaces 420 and 430 into a central location that is accessible by client devices, such as client device 460.

The client device 460 may log onto the virtual marketplace aggregator 410 and obtain access to catalogs of goods/services of suppliers 440-450 which are registered with marketplaces 420 and 430. The virtual marketplace aggregator 410, for example, may provide the client device 460 with one or more web pages, applets, or the like, through which the user of the client device 460 may be informed of the various marketplaces supported by the virtual marketplace aggregator 410.

For example, the vital marketplace aggregator may provide the client device 460 with a web page indicating that the virtual marketplace aggregator 410 currently supports “The Jewelry Exchange” marketplace, the “Do It Yourself Hardware” marketplace, the “Computer Gizmos” marketplace, and the like. Thus, if the user wishes to obtain information regarding goods/services in the category of computer hardware, the user may select the Computer Gizmos marketplace. Similarly, if the user is interested in purchasing jewelry, the user may select The Jewelry Exchange marketplace. When the user selects a marketplace, the user is then provided with one or more web pages containing information regarding the various suppliers registered with that marketplace including any catalogs of goods/services offered by those suppliers.

In a further embodiment, the user may be provided with a global search tool, via an applet, web page, or the like. The global search tool may be used to enter search terms such that a search of all marketplaces, and suppliers registered with such marketplaces, are searched to determine if they conform to the search terms. In this way, the user may search a plurality of marketplaces from a central network site. Moreover, the suppliers need only register with a single marketplace and be exposed to a larger group of potential customers.

FIG. 5 is an exemplary block diagram of a virtual marketplace aggregator according to the present invention. As shown in FIG. 5, the virtual marketplace aggregator includes a controller 510, a marketplace aggregation engine 520, a virtual marketplace user interface engine 530, a network interface 540 and a marketplace storage device 550. The elements 510-550 are coupled to one another via the control/data bus 560. Although a bus architecture is shown in FIG. 5, other architectures that facilitate the exchange of control messages and data between elements 510-550 may be used without departing from the spirit and scope of the present invention.

The controller 510 performs the overall control functions of the virtual marketplace aggregator and sends control messages to each of the elements 520-550 via the control/data bus 560 to instruct the elements to perform various functions. The controller 510, as well as the other elements 520-550, may be implemented in software, hardware, such as the hardware shown in FIG. 2, or a combination of software and hardware. For example, the controller 510 may be implemented as instructions executed by the processor 202.

The network interface 540 provides an interface between the virtual marketplace aggregator and the network 102. The network interface 540 both receives messages from the network 102 and sends messages to the network 102. The network interface 540 may be implemented in a telephone line based modem, cable modem, wireless modem, local area network card, router, switch or other interface mechanism for communicating with a data network. The network interface 540 may make use of accepted communication protocols to communicate with the network 102.

The marketplace aggregation engine 520 performs the functions necessary to aggregate marketplace information into a uniform information base. The marketplace aggregation engine 520 may broadcast requests via the network interface 540 such that newly established marketplaces, or marketplaces having newly registered suppliers, will respond to the request with information identifying the marketplace/registered suppliers. The received information is then aggregated by the marketplace aggregation engine 520 into a uniform database data structure that is stored in the marketplace storage device 550.

The virtual marketplace user interface engine 530 provides web pages, applets, or the like, through which a user of a client device may obtain information regarding marketplaces and/or suppliers that are registered in the marketplace data structure stored in the marketplace storage device 550. The virtual marketplace user interface engine 530 may further provide a global search tool through which a user of a client device may perform a search of the marketplaces and/or suppliers in the marketplace data structure.

In addition, the virtual marketplace user interface engine 530 may provide one or more web pages, applets, or the like through which a user of a client device may place orders for goods/services offered by marketplaces and/or suppliers registered in the marketplace data structure. The user interface for placing the orders is the same regardless of the particular marketplace or supplier that is to ultimately receive the order. Thus, the virtual marketplace user interface engine 530 provides a simple, uniform and easily comprehensible interface through which the user can place orders with a variety of different marketplaces and suppliers.

When an order is placed using the virtual marketplace user interface engine 530, the input from the user is received via the network interface 540 and provided to controller 510. The controller 510 then reformats the received data into a format used by the particular marketplace/supplier that is to receive the order. The reformatting is performed based on transaction format information stored in the marketplace data structure of the marketplace storage device 550 and upon an indicator of the marketplace/supplier in, for example, a header of the order message received from the user's client device.

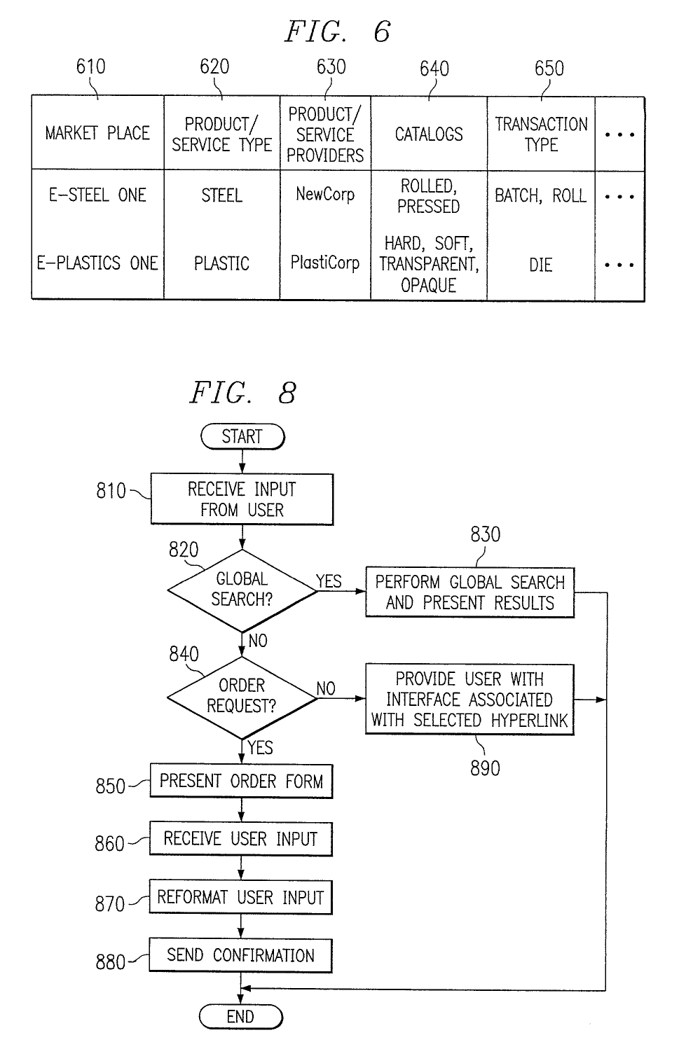

FIG. 6 is an exemplary block diagram illustrating a marketplace data structure according to the present invention. As shown in FIG. 6, the marketplace data structure contains a field 610 for identifying the marketplace, a field 620 for identifying the product/service types registered with the marketplace, a field 630 for identifying the suppliers registered with the marketplace that offer that product/service type, a field 640 for providing catalog information for each of the registered marketplaces/suppliers, and a field 650 for identifying a transaction format. Other fields may be provided in addition to, or in replacement of, the fields 610-650 shown in FIG. 6.

FIG. 7 is a flowchart outlining an exemplary operation of the present invention when compiling marketplace information from various marketplaces on a network. As shown in FIG. 7, the operation starts with a request being broadcast over the network (step 710). The request is a request for marketplace sites to provide information about the marketplace and suppliers registered with the marketplace. Responses to the request are then received (step 720). The marketplace data structure is then updated based on the received responses (step 730). The operation then ends.

FIG. 8 is a flowchart outlining an exemplary operation of the present invention when processing an input from a user. As shown in FIG. 8, the operation starts with receiving an input from a user via a client device (step 810). A determination is made as to whether the user inputs a global search (step 820). If so, the global search is performed and results presented to the user (step 830). If not, a determination is made as to whether the user inputs a request to order a good/service (step 840).

If the user requests to order a good/service, the user is presented with an order form user interface (step 850). The user's input to the order form user interface is received (step 860) and converted to a proper format for an identified marketplace/supplier (step 870). A confirmation may the be provided to the user (step 880).

If the user does not request to order a good/service, the user may have selected a hyperlink to a marketplace or supplier. The user is then presented with an appropriate web page/applet associated with the selected hyperlink (step 890). The operation then ends. This operation may be repeated each time an input is received from a user.

Thus, the present invention provides a mechanism by which multiple marketplaces may be aggregated together at a central location. In so doing, users may make use of a single central location to search and identify marketplaces and/or suppliers of goods and services. In addition, a uniform ordering system is provided, from the viewpoint of the user, while maintaining the transaction formats of the individual marketplaces and suppliers. Moreover, the suppliers of goods/services need register with only one or a few marketplaces and be provided with exposure to a much larger potential customer base due to the aggregation of a plurality of marketplaces.

It is important to note that while the present invention has been described in the context of a fully functioning data processing system, those of ordinary skill in the art will appreciate that the processes of the present invention are capable of being distributed in the form of a computer readable medium of instructions in a variety of forms and that the present invention applies equally regardless of the particular type of signal bearing media actually used to carry out the distribution. Examples of computer readable media include recordable-type media such a floppy disk, a hard disk drive, a RAM, a CD-ROM, and transmission-type media such as digital and analog communications links.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of providing a client device with information regarding a plurality of marketplaces, comprising:
aggregating a plurality of marketplaces into an aggregated marketplace; and
providing the client device with marketplace information for one or more of the plurality of marketplaces.

2. The method of claim 1, further comprising:
receiving a selection of a marketplace from the one or more of the plurality of marketplaces; and
providing the client device with supplier information associated with the selected marketplace.

3. The method of claim 1, wherein each of the plurality of marketplaces is directed to a particular type of good/service.

4. The method of claim 1, wherein providing the client device with marketplace information includes:
providing the client device with a search tool;
receiving a search request via the search tool, the search request including one or more search criteria; and
providing marketplace information meeting the one or more search criteria.

5. The method of claim 1, wherein aggregating a plurality of marketplaces includes:
broadcasting a request for marketplace information over at least one network;
receiving marketplace information from the plurality of marketplaces in response to the broadcasting of the request; and
registering the marketplace information from the plurality of marketplaces with the aggregated marketplace.

6. The method of claim 5, wherein registering the marketplace information from the plurality of marketplaces with the aggregated marketplace includes aggregating the marketplace information into a uniform database data structure.

7. The method of claim 1, wherein providing the client device with marketplace information for one or more of the plurality of marketplaces includes providing the client device with one of a web page and an applet through which the client device may obtain the marketplace information.

8. The method of claim 2, wherein the supplier information includes one or more catalogs of goods/services provided by a corresponding supplier.

9. The method of claim 1, further comprising:
providing the client device with an interface through which a user of the client device may place an order for a good/service.

10. The method of claim 2, further comprising:
receiving, from the client device, an order for a good/service from a supplier based on the supplier information.

11. The method of claim 10, wherein the order is formatted using a uniform format, and wherein the method further comprises reformatting the order based on a format used by the supplier.

12. The method of claim 11, wherein the order is reformatted based on transaction format information for the supplier stored in association with the aggregated marketplace.

13. The method of claim 2, wherein receiving a selection of a marketplace from the one or more of the plurality of marketplaces includes receiving a selection of a hyperlink from a web page, the hyperlink being associated with the marketplace.

14. A method for aggregating a plurality of electronic marketplaces, comprising:
registering one or more suppliers with a plurality of marketplaces;
registering the plurality of marketplaces with a marketplace aggregator; and
aggregating registration information for the one or more suppliers associated with each of the plurality of marketplaces into a central marketplace.

15. The method of claim 1, wherein registering the plurality of marketplaces with a marketplace aggregator includes:
broadcasting a request for marketplace information to the plurality of marketplaces;
receiving marketplace information from the plurality of marketplaces in response to the broadcasting of the request; and
storing the marketplace information in a marketplace data structure in the marketplace aggregator.

16. An apparatus for providing a client device with information regarding a plurality of marketplaces, comprising:
means for aggregating a plurality of marketplaces into an aggregated marketplace; and
means for providing the client device with marketplace information for one or more of the plurality of marketplaces.

17. The apparatus of claim 16, further comprising:
means for receiving a selection of a marketplace from the one or more of the plurality of marketplaces; and
means for providing the client device with supplier information associated with the selected marketplace.

18. The apparatus of claim 16, wherein each of the plurality of marketplaces is directed to a particular type of good/service.

19. The apparatus of claim 16, wherein the means for providing the client device with marketplace information includes:
means for providing the client device with a search tool;
means for receiving a search request via the search tool, the search request including one or more search criteria; and
means for providing marketplace information meeting the one or more search criteria.

20. The apparatus of claim 16, wherein the means for aggregating a plurality of marketplaces includes:
means for broadcasting a request for marketplace information over at least one network;
means for receiving marketplace information from the plurality of marketplaces in response to the broadcasting of the request; and
means for registering the marketplace information from the plurality of marketplaces with the aggregated marketplace.

21. The apparatus of claim 20, wherein the means for registering the marketplace information from the plurality of marketplaces with the aggregated marketplace includes means for aggregating the marketplace information into a uniform database data structure.

22. The apparatus of claim 16, wherein the means for providing the client device with marketplace information for one or more of the plurality of marketplaces includes means for providing the client device with one of a web page and an applet through which the client device may obtain the marketplace information.

23. The apparatus of claim 17, wherein the supplier information includes one or more catalogs of goods/services provided by a corresponding supplier.

24. The apparatus of claim 16, further comprising:
means for providing the client device with an interface through which a user of the client device may place an order for a good/service.

25. The apparatus of claim 17, further comprising:
means for receiving, from the client device, an order for a good/service from a supplier based on the supplier information.

26. The apparatus of claim 25, wherein the order is formatted using a uniform format, and wherein the apparatus further comprises means for reformatting the order based on a format used by the supplier.

27. The apparatus of claim 26, wherein the order is reformatted based on transaction format information for the supplier stored in association with the aggregated marketplace.

28. The apparatus of claim 17, wherein the means for receiving a selection of a marketplace from the one or more of the plurality of marketplaces includes means for receiving a selection of a hyperlink from a web page, the hyperlink being associated with the marketplace.

29. An apparatus for aggregating a plurality of electronic marketplaces, comprising:
means for registering one or more suppliers with a plurality of marketplaces;
means for registering the plurality of marketplaces with a marketplace aggregator; and
means for aggregating registration information for the one or more suppliers associated with each of the plurality of marketplaces into a central marketplace.

30. The apparatus of claim 29, wherein the means for registering the plurality of marketplaces with a marketplace aggregator includes:
means for broadcasting a request for marketplace information to the plurality of marketplaces;
means for receiving marketplace information from the plurality of marketplaces in response to the broadcasting of the request; and
means for storing the marketplace information in a marketplace data structure in the marketplace aggregator.

31. A computer program product in a computer readable medium for providing a client device with information regarding a plurality of marketplaces, comprising:
first instructions for aggregating a plurality of marketplaces into an aggregated marketplace; and
second instructions for providing a client device with marketplace information for one or more of the plurality of marketplaces.

32. The computer program product of claim 1, further comprising:
third instructions for receiving a selection of a marketplace from the one or more of the plurality of marketplaces; and
fourth instructions for providing the client device with supplier information associated with the selected marketplace.

33. The computer program product of claim 31, wherein the second instructions include:
instructions for providing the client device with a search tool;
instructions for receiving a search request via the search tool, the search request including one or more search criteria; and
instructions for providing marketplace information meeting the one or more search criteria.

34. The computer program product of claim 1, wherein the first instructions include:
instructions for broadcasting a request for marketplace information over at least one network;
instructions for receiving marketplace information from the plurality of marketplaces in response to the broadcasting of the request; and
instructions for registering the marketplace information from the plurality of marketplaces with the aggregated marketplace.

35. The computer program product of claim 32, further comprising:
fifth instructions for receiving, from the client device, an order for a good/service from a supplier based on the supplier information.

36. The computer program product of claim 35, wherein the order is formatted using a uniform format, and wherein the computer program product further comprises sixth instructions for reformatting the order based on a format used by the supplier.

37. A computer program product in a computer readable medium for aggregating a plurality of electronic marketplaces, comprising:
first instructions for registering one or more suppliers with a plurality of marketplaces;
second instructions for registering the plurality of marketplaces with a marketplace aggregator; and
third instructions for aggregating registration information for the one or more suppliers associated with each of the plurality of marketplaces into a central marketplace.

38. The computer program product of claim 37, wherein the second instructions includes:
instructions for broadcasting a request for marketplace information to the plurality of marketplaces;
instructions for receiving marketplace information from the plurality of marketplaces in response to the broadcasting of the request; and
instructions for storing the marketplace information in a marketplace data structure in the marketplace aggregator.

39. A distributed data processing system, comprising:
a plurality of supplier systems;
a plurality of marketplace systems; and
a marketplace aggregator, wherein the plurality of supplier systems is comprised of a plurality of subsets of supplier systems, each subset being registered with one or more of the plurality of marketplace systems, and wherein two or more marketplace systems of the plurality of marketplace systems are registered with the marketplace aggregator.
